(19) United States
(12) Patent Application Publication
(10) Pub. No.: US 2004/0165547 A1
(43) Pub. Date: Aug. 26, 2004

(54) Method for providing a communication channel in time division duplexing (tdd) mode between a tdd mobile and a tdd base station

(76) Inventor: Luis Lopes, Swindon (GB)

Correspondence Address: MOTOROLA, INC., 1303 EAST ALGONQUIN ROAD, IL01/3RD, SCHAUMBURG, IL, 60196

(21) Appl. No.: 10/480,697

(22) PCT Filed: Jun. 18, 2002
(86) PCT No.: PCT/EP02/03090

(51) Int. Cl. H04Q 7/00

(52) U.S. Cl. 370/328

(57) ABSTRACT

The amount of interference to communications in Time Division Duplexing (TDD) mode between a TDD mobile and a TDD base station from a mobile operating in Frequency Division Duplexing (FDD) mode that is located near to the TTD base station can be reduced by changing at least the frequency channel allocated to a particular TDD communications channel, and prefereably also by changing the timeslot allocated to that particular TDD communications channel. Thus instead of allocating particular frequency channels to particular operators for TDD communication, the frequency channels used by any particular operator for TDD communication can change from frame to frame. The timeslots within a frame on a frequency channel may stay the same or may also change. Thus, any particular communications channel (6,8) will not remain on the same frequency channel, nor, possibly, on the same timeslot within a frame, from one frame to the next, so that no one TDD channel will have continuous interference from an FDD channel, but all the TDD communications channels will have the interference shared between them.

### FIELD OF THE INVENTION

This invention relates to a method for providing a communications channel in Time Division Duplexing (TDD) mode between a TDD mobile and a TDD base station, particularly, though not exclusively, to a method for reducing interference to communications in Time Division Duplexing (TDD) mode between a TDD mobile and a TDD base station from a mobile operating in Frequency Division Duplexing (FDD) mode that is located near to the TDD base station.

### BACKGROUND OF THE INVENTION

In the Universal Mobile Telecommunications System (UMTS) communications between a mobile station, e.g. a cellular telephone, and a base station require both an uplink channel (from the mobile to the base station) and a downlink channel (from the base station to the mobile). It is usual for the channels to be provided either as a Time Division Duplexing (TDD) or a Frequency Division Duplexing system. Often different operators within the same coverage area will have one or both systems available for their customers.

In TDD, a particular frequency channel is divided into time frames, with each frame being subdivided into a plurality of timeslots. Some of the timeslots in each frame are designated for uplinking and some are designated for downlinking, with a particular mobile being allocated particular uplink and downlink timeslots for a particular communication session. Of course, different operators will, in general, have different frequency channels allocated to them.

In FDD, a number of frequency channel are available as communication channels and, for a particular communication session with a mobile, the operator will allocate one frequency channel as an uplink channel and one frequency channel as a downlink channel. Those particular frequency channels then remain available all the time for that mobile for the duration of the communication session.

When a mobile station operating in FDD mode moves about a particular base station coverage area, it is controlled to increase or decrease its transmission power depending on how close to the base station it is at any particular time. It will thus be apparent that if the mobile is at a relatively far distance from the base station, its transmission power will be high. If it should happen that the mobile is close to a base station operating in TDD mode, then any frequency channels available for the TDD communication that are adjacent the FDD uplink channel that the mobile is communicating on will have interference from the FDD mobile due to power leaking across adjacent frequency channels from the FDD uplink channel. Such leakage can desensitise the TDD base station by causing it to reduce its reception sensitivity in the TDD frequency channels adjacent the FDD uplink channel so that it can no longer adequately receive TDD uplink communication in those frequency channels.

This problem can occur even when the FDD mobile is close to the FDD base station if that happens to be co-located or closely located to the TDD base station and the FDD uplink channel has a broad transmission frequency spectrum. One way to overcome the problem is to use very sharp RF filters to preclude or reduce any crossover from the FDD uplink channel to adjacent channels, but such filters can be costly.

### BRIEF SUMMARY OF THE INVENTION

The present invention therefore seeks to provide a method for providing a communications channel in Time Division Duplexing (TDD) mode between a TDD mobile and a TDD base station, which overcomes, or at least reduces, the above-mentioned problems of the prior art.

Accordingly, in a first aspect, the invention provides a method for providing a communications channel in Time Division Duplexing (TDD) mode between a TDD mobile and a TDD base station, the method comprising the steps of:

designating a plurality of frequency channels available for TDD communications, each frequency channel having a plurality of uplink timeslots and a plurality of downlink timeslots defined within a frame;

designating an uplink channel for a communication session between a TDD mobile and a TDD base station as a series of uplink timeslots, one uplink timeslot being designated for each frame for the duration of the communication session;

designating a downlink channel for a communication session between a TDD mobile and a TDD base station as a series of downlink timeslots, one downlink timeslot being designated for each frame for the duration of the communication session;

the TDD base station determining, at the beginning of a communication session, which uplink and downlink channels are available for use; and

the TDD base station communicating to the TDD mobile, at the beginning of the communication session, which uplink and downlink channels are allocated for that communication session;

wherein the timeslots forming the uplink and downlink channels are designated to be on different frequency channels in different frames.

According to a second aspect, the invention provides a method for reducing interference to communications in Time Division Duplexing (TDD) mode between a TDD mobile and a TDD base station, the method comprising the steps of:

designating a plurality of frequency channels available for TDD communications, each frequency channel having a plurality of uplink timeslots and a plurality of downlink timeslots defined within a frame;

designating an uplink channel for a communication session between a TDD mobile and a TDD base station as a series of uplink timeslots, one uplink timeslot being designated for each frame for the duration of the communication session;

designating a downlink channel for a communication session between a TDD mobile and a TDD base station as a series of downlink timeslots, one downlink timeslot being designated for each frame for the duration of the communication session;

the TDD base station determining, at the beginning of a communication session, which uplink and downlink channels are available for use; and

the TDD base station communicating to the TDD mobile, at the beginning of the communication session, which uplink and downlink channels are allocated for that communication session;

wherein the timeslots forming the uplink and downlink channels are designated to be on different frequencies in different frames.

### BRIEF DESCRIPTION OF THE DRAWINGS

One embodiment of the invention will now be more fully described, by way of example, with reference to the drawings, of which:

FIG. 1 shows a schematic diagram of frequency channel and timeslot allocations for FDD and TDD channels in a known communications system;

FIG. 2 shows a schematic diagram of a frequency channel and timeslot allocation for FDD and TDD channels in a communications system according to on embodiment of the present invention; and

FIG. 3 shows a schematic diagram of a communications system utilizing the frequency channel and timeslot allocation of FIG. 2.

### DETAILED DESCRIPTION OF THE DRAWINGS

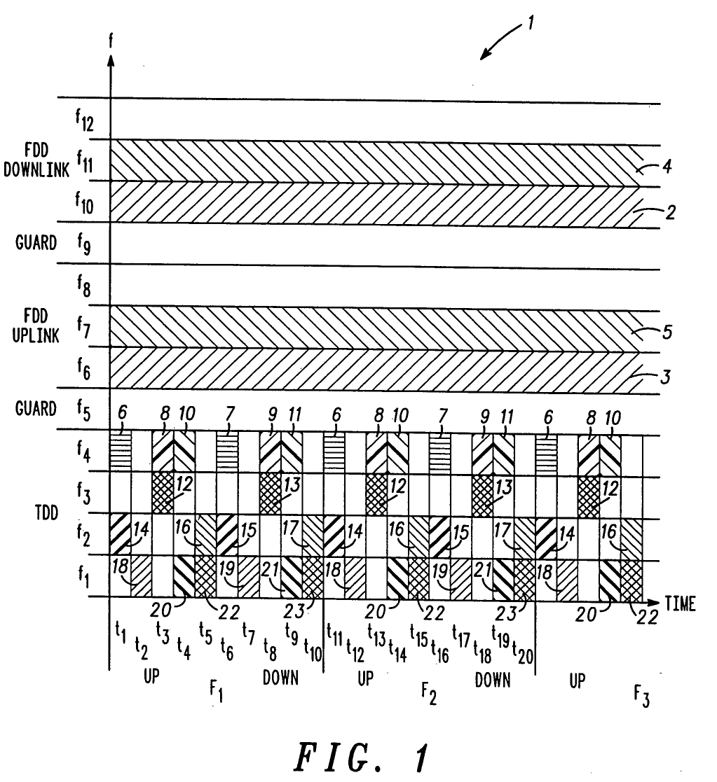

FIG. 1 shows a schematic diagram 1 showing different frequency channel f and timeslots t that might be available for communications. Known communications systems have particular frequency channels allocated to them for use as communications channels between base stations of a network and mobile stations utilizing the network. As mentioned above, a network operator often provides service to mobiles in either a Frequency Division Duplexing (FDD) mode or a Time Division Duplexing (TDD) mode. Often, different frequency channels to be used for TDD communications channels are allocated to different operators.

For example, as shown in FIG. 1, frequency channels f₁, f₂, f₃, and f₄ are allocated for TDD communications and may be allocated to more than one operator. Frequency channels f₆, f₇, f₈, f₉, f₁₀, f₁₁, and f₁₂ are allocated for FDD communications, with frequency channels f₆, f₇ and f₈ being used for uplink channels and frequency channels f₁₀, f₁₁ and f₁₂ being used for downlink channels. Frequency channel f₉ provides a guardband between the uplink and downlink channels and frequency channel f₅ provides a guardband between the FDD frequency channels and the TDD frequency channels. It will be appreciated that the guardbands need not have the same bandwidth. Indeed, often, the bandwidth of the guardband between the FDD uplink and downlink channels is much greater than the bandwidth of the guardband between the FDD uplink channel and the TDD channels. Thus, for example, frequency channel f₁₀ may be used by the FDD operator for a downlink channel 2 for a communications session with a particular mobile, with frequency channel f₆ being similarly used for that communication session as an uplink channel 3. Frequency channels f₇ and f₁₁ may similarly be used by a different mobile as downlink channel 4 and uplink channel 5 for a communication session. Of course, the same frequency band may well be shared by a number of mobiles by either using different codes (for FDD communication) or different timeslots and codes (in TDD communication).

In TDD communications, an operator having a frequency channel may allocate different timeslots within a frame F to different mobiles for different communications sessions. Each frame F is generally divided into two sections, one for uplink channels and one for downlink channels. For example, an operator having frequency channel f₄ allocated to it, may allocate a first timeslot t₁ in the uplink section of first frame F₁ to a first mobile as an uplink channel 6, with corresponding timeslot t₆ in the downlink section similarly being allocated to the same mobile as the downlink channel 7. Clearly, the corresponding timeslots t₁₁ and t₁₆ in the second frame F₂, and in subsequent frames will be allocated to that same mobile until the communication session is complete. In FIG. 1, timeslots t₃ and t₈ in the first frame F₁, and timeslots t₁₃ and t₁₈ in the second frame F₂ are allocated to a second mobile as uplink and downlink channels 8 and 9, respectively, and timeslots t₄ and t₉ in the first frame F₁ and timeslots t₁₄ and t₁₉ in the second frame F₂ are allocated to a third mobile as uplink and downlink channels 10 and 11, respectively. Similarly, on frequency channel f₃ timeslots t₃ and t₈ in the first frame F₁ and timeslots t₁₃ and t₁₈ in the second frame F₂ are allocated to a fourth mobile as uplink and downlink channels 12 and 13, respectively, while on frequency channels f₂ and f₁, the first and fifth, and the first, fourth and fifth timeslots in each section of each frame are shown allocated to different mobiles as uplink and downlink channels 16, 18, 20, 22 and 17, 19, 21, 23 respectively.

It will, of course, be appreciated that the frequency channels f are not as sharply defined as indicated in the drawing. On the contrary, the signals on any particular frequency channel are likely to cross-over into one or more adjacent frequency channels, especially at higher powers, as mentioned above. Therefore, although the guardbands f₅ and f₉ are intended to provide the necessary separation to prevent excessive cross-over, some cross-over from, for example frequency channel f₆ may well occur into frequency channel f₄, even across the guardband f₅, especially if the signal on frequency channel f₆ is at a relatively high power, for example, because a mobile using that channel is located at a considerable distance from the FDD base station with which it is communicating, although it may be located relatively close to a TDD base station. As explained above, in this situation, the TDD base station communicating on frequency channel f₄ may become relatively desensitized by the interference on this frequency channel from the FDD communication on frequency channel f₆, so that it adversely affects the quality of the TDD communication on this frequency channel. If this frequency channel f₄ has been allocated to an operator who, perhaps, has not been allocated any or many other frequency channels, the adverse effect on quality may be particularly undesirable.

Therefore, according to a first embodiment of the present invention, the amount of interference to communications in Time Division Duplexing (TDD) mode between a TDD mobile and a TDD base station can be reduced by changing at least the frequency channel allocated to a particular TDD communications channel, and preferably also by changing the timeslot allocated to that particular TDD communications channel. Thus, instead of allocating particular frequency channels to particular operators for TDD communication, the frequency channels used by any particular operator for TDD communication can change from frame to frame. For example, the operator may be allocated a particular frequency channel changing sequence, so that, starting at some reference time, the frequency channel used may change for each frame in a predetermined sequence. The timeslots within a frame on a frequency channel may stay the same or may also change. Thus, any particular communications channel will not remain on the same frequency channel, nor, possibly, on the same timeslot within a frame, from one frame to the next, so that no channel will have continuous interference from an FDD, or indeed any other, interference source, but all the communications channels will have the interference shared between them.

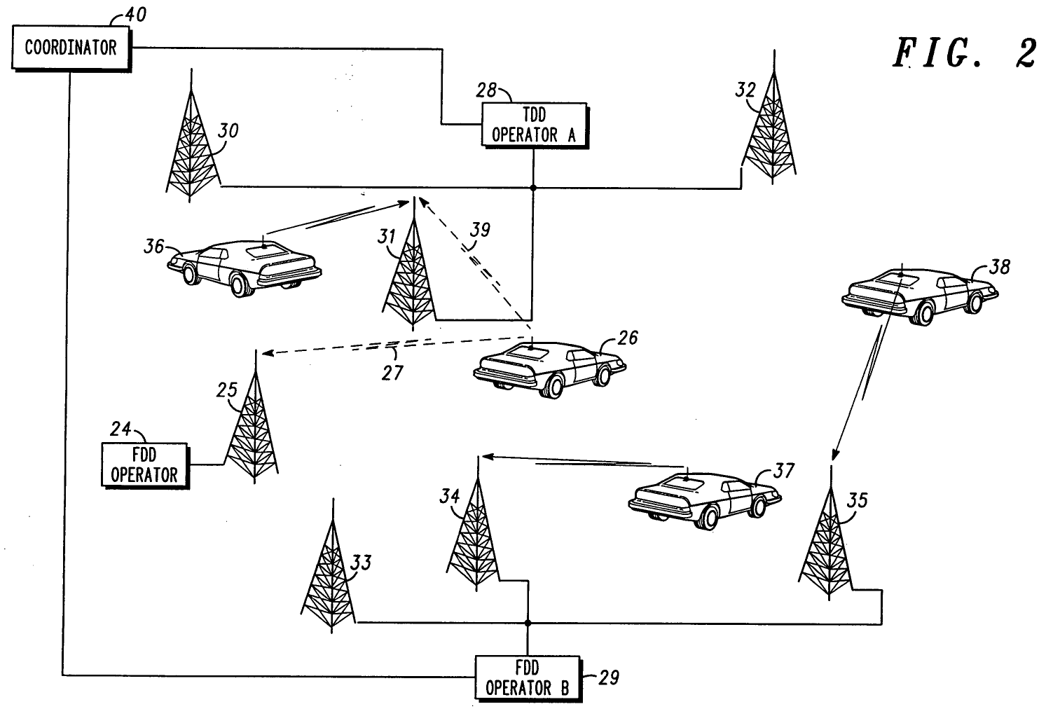

As shown in FIG. 2, a communication system includes an FDD operator 24 coupled to control an FDD base station 25 and an FDD mobile 26 communicating with the FDD base station 25, as shown by dotted line link 27. A communication system operating in TDD mode has two operators 28 and 29, each controlling three TDD base stations 30, 31, 32 and 33, 34, 35. A first TDD mobile 36 is in TDD communication with TDD base station 31, a second TDD mobile 37 is in communication with TDD base station 34 and a third TDD mobile 38 is in communication with TDD base station 35. As shown, the FDD mobile 26 is closer to the TDD base station 31, than to FDD base station 25 and is causing interference, as shown by dotted line link 39 with the TDD base station 31. As explained above, if TDD operator A 28 was only allocated one frequency channel, then there would be little that could be done to mitigate the effects of the interference from FDD mobile 26 to the communication from TDD mobile 36 to the TDD base station 31 on this frequency channel.

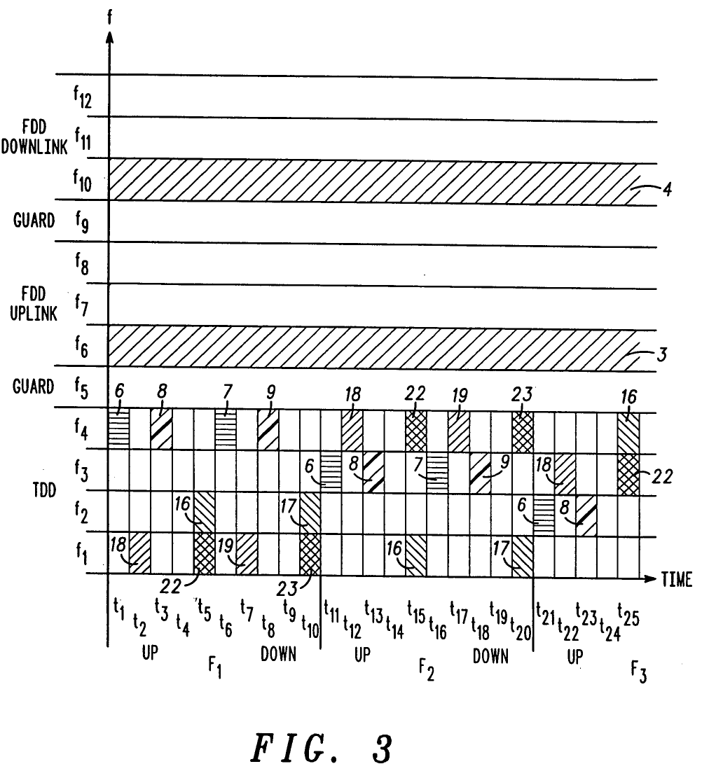

However, in the present embodiment, the two TDD operators 28 and 29 are linked to a coordinator 40, which allocates the frequency channels to the operators. As shown in FIG. 3, the uplink and downlink channels for each of the TDD channels are moved across the available frequency channels and timeslots within frames from one frame to an adjacent frame in a predetermined sequence. In FIG. 3, elements which are identical to those of FIG. 1 are shown with the same reference numbers. However, the numbers of channels actually shown in use is smaller than for FIG. 1 for simplicity. Thus, in this case only a single FDD communication session is shown, with uplink channel 3 on frequency channel f₆ and downlink channel 4 on frequency channel f₁₀ representing the communication between FDD mobile 26 and FDD base station 25. Only five separate TDD communication sessions are shown in FIG. 3, rather than the nine sessions shown in FIG. 1. In this case, a first mobile, for example TDD mobile 36 in FIG. 2 has an uplink channel 6 and a downlink channel 7 allocated to it and a second mobile (not shown in FIG. 2) has an uplink channel 8 and a downlink channel 9 allocated to it. A third TDD mobile (also not shown in FIG. 2) has an uplink channel 16 and a downlink channel 17 allocated to it, and fourth and fifth TDD mobiles, for example TDD mobiles 37 and 38 in FIG. 2, have uplink channels 18, 22 and downlink channels 19, 23 allocated to them, respectively. For simplicity, referring now solely to the uplink channels, it will be seen that uplink channels 6 and 8 are located in timeslots t₁ and t₃ in frequency channel f₄ in frame F₁, uplink channel 16 is located in timeslot t₅ in frequency channel f₂ and uplink channels 18 and 22 are located in timeslots t₂ and t₅ in frequency channel f₁ in frame F₁.

However, in frame F₂, instead of being in the same timeslots in the same frequency channels, all the channels have been moved to different frequency channels according to a predetermined sequence. In this case, the channels have moved down one frequency channel, except for those in frequency channel f₁, which have moved to frequency channel f₄. Thus, uplink channels 6 and 8 are now located in timeslots t₁ and t₃ in frequency channel f₃ in frame F₂, uplink channel 16 is located in timeslot t₅ in frequency channel f₁ and uplink channels 18 and 22 are located in timeslots t₂ and t₅ in frequency channel f₄ in frame F₂. Similarly, for the next frame F₃, uplink channels 6 and 8 are located in timeslots t₁ and t₃ in frequency channel f₂ in frame F₃, uplink channel 16 is located in timeslot t₅ in frequency channel f₄ and uplink channels 18 and 22 are located in timeslots t₂ and t₅ in frequency channel f₃ in frame F₃. Although the sequence of frequency channel hopping is predetermined, the coordinator 40 is used to provide reference times so that at predetermined intervals all the TDD operators connected to the coordinator can make sure that they are properly synchronized.

In this way, none of the channels are on frequency channel f₄, which is most likely to experience interference from FDD channel 3 on frequency channel f₆ in all frames, but are spread out over all the available TDD frequency channels. Of course, the sequence of frequency channels need not be a simple rolling sequence, such as the one illustrated, but can be different. For example, there could be a pseudo-random sequence, which is predetermined, so that all operators receive the sequence of frequency channels to be “hopped across” instead of one or more frequency channels being allocated exclusively for any particular operator. The important feature, in this case, is that the operator is provided with the information as to the order of the frequency channels to be used, and, of course, reference times for synchronization of the frequency channel changing. Although the sequences referred to so far have been considered to be periodic, in other words, the frequency channel sequence is finite and then repeats itself, it will be apparent that the sequences could be dynamically altered by the coordinator, if desired, based on prevailing circumstances, for example, the amount of the traffic on the system, the amount of interference, etc. Thus, if there is little traffic on the system, then it may be possible to adjust the sequence to avoid altogether the frequency channel(s) on which most interference occurs.

It will also be apparent that the coordinator could allocate batches of timeslot and frequency channel hopping sequences to an operator so that the operator can then use those sequences in any manner the operator wants without needing to revert to the coordinator for a new sequence for each individual communication session.

Although, in the above embodiment the timeslots allocated to a channel do not change from one frame to the next—only their frequency channel changes, as mentioned above, the timeslots within each frame that a particular channel is allocated may also be changed. Thus, it is possible for different operators to be allocated different timeslots on the same frequency channel, if desired. This would obviously necessitate that the coordinator carry out more control over the operators than simply synchronizing them, but the controlling process will be fairly simple in principle and will not be further described here. Changing the timeslots that are allocated to a particular channel can take place with any of the types of frequency channel changing sequences described above. Thus, apart from the simple case of scrolling frequency channel changes illustrated above, where the timeslots may also be altered from one frame to the next in a predetermined sequence, timeslot changes can also occur even if the frequency channel changes are pseudo-random or dynamic.

In the case where the frequency channel changes are predetermined, whether simple, scrolling or pseudo-random, or some other predetermined sequence, if the sequence is given to an operator such that that operator has exclusive use of any particular frequency channel for a frame, then the timeslot changes, should they be desired, can be undertaken by the operator without the need for the coordinator to provide timeslot change sequences. However, of course, it is also possible for the coordinator to provide timeslot as well as frequency channel change sequences, such that, for example, an operator is simply given a number of sequences of changes and the operator then allocates a particular sequence for a particular communication session. Of course, if the frequency channel changes are dynamic, then it would be preferable for any timeslot changes also to be controlled by the coordinator, such that the coordinator then need only provide the sequence of changes to each operator on a dynamic basis. The information provided to an operator regarding sequences of changes may be relative changes, such as changing the frequency channel by x frequency channels up or down and the timeslot by y timeslots up or down, or may be absolute by providing the actual timeslot frequency channel and timing to be used for each frame.

Clearly, the operator will need to provide the appropriate channel information to the mobile at the beginning of each communication session, and, perhaps, during the communication session, especially if the sequences of frequency channels and, if applicable, timeslots are being changed on a dynamic basis. This information can be provided to the mobile in any known convenient manner and will not be further described herein.

It will be appreciated that although only one particular embodiment of the invention has been described in detail, various modifications and improvements can be made by a person skilled in the art without departing from the scope of the present invention.

1. A method for providing a communications channel in Time Division Duplexing (TDD) mode between a TDD mobile and a TDD base station, the method comprising the steps of:
designating a plurality of frequency channels available for TDD communications, each frequency channel having a plurality of uplink timeslots and a plurality of downlink timeslots defined within a frame;
designating an uplink channel for a communication session between a TDD mobile and a TDD base station as a series of uplink timeslots, one uplink timeslot being designated for each frame for the duration of the communication session;
designating a downlink channel for a communication session between a TDD mobile and a TDD base station as a series of downlink timeslots, one downlink timeslot being designated for each frame for the duration of the communication session;
the TDD base station determining, at the beginning of a communication session, which uplink and downlink channels are available for use; and
the TDD base station communicating to the TDD mobile, at the beginning of the communication session, which uplink and downlink channels are allocated for that communication session; wherein the timeslots forming the uplink and downlink channels are designated to be on different frequencies in different frames.

2. A method for providing a communications channel according to claim 1, wherein the timeslots forming the uplink and downlink channels are designated to be at different times for different frames.

3. A method for providing a communications channel according to either claim 1 or claim 2, wherein the series of timeslots forming the uplink and downlink channels are designated as sequences of timeslots on different frequency channels and at different times for different frames.

4. A method for providing a communications channel according to claim 3, wherein the sequences of timeslots are predefined and wherein the predefined sequence is communicated to the TDD mobile at the beginning of the communication session.

5. A method for providing a communications channel according to claim 3, wherein the sequences of timeslots are dynamically designated and the frequency channel and time of succeeding timeslots are communicated to the TDD mobile in at least one preceding downlink timeslot.

6. A method for providing a communications channel according to any preceding claim, wherein an operator designates the timeslots across the frequency channels allocated to that operator.

7. A method for providing a communications channel according to any one of claims 3, 4 or 5, wherein an operator is provided with the sequences of timeslots available to that operator over all frequency channels available to all operators, whereby the same frequency channels and timeslots in different frames are shared by different operators.

8. A method for providing a communications channel according to claim 7, wherein the sequences of timeslots available to an operator are dynamically designated.

9. A method for providing a communications channel according to either claim 5 or claim 8, wherein the sequences of timeslots are changed during the course of a communication session.

10. A method for reducing interference to communications in Time Division Duplexing (TDD) mode between a TDD mobile and a TDD base station, the method comprising the steps of:
designating a plurality of frequency channels available for TDD communications, each frequency channel having a plurality of uplink timeslots and a plurality of downlink timeslots defined within a frame;
designating an uplink channel for a communication session between a TDD mobile and a TDD base station as a series of uplink timeslots, one uplink timeslot being designated for each frame for the duration of the communication session;
designating a downlink channel for a communication session between a TDD mobile and a TDD base station as a series of downlink timeslots, one downlink timeslot being designated for each frame for the duration of the communication session;
the TDD base station determining, at the beginning of a communication session, which uplink and downlink channels are available for use; and
the TDD base station communicating to the TDD mobile, at the beginning of the communication session, which uplink and downlink channels are allocated for that communication session; wherein the timeslots forming the uplink and downlink channels are designated to be on different frequency channels in different frames.

11. A method for reducing interference to communications in Time Division Duplexing (TDD) mode according to claim 10, wherein the timeslots forming the uplink and downlink channels are designated to be at different times for different frames.

12. A method for reducing interference to communications in Time Division Duplexing (TDD) mode according to either claim 10 or claim 11, wherein the series of timeslots forming the uplink and downlink channels are designated as sequences of timeslots on different frequency channels and at different times for different frames.

13. A method for reducing interference to communications in Time Division Duplexing (TDD) mode according to any one of claims 10 to 12, wherein the sequences of timeslots are predefined and wherein the predefined sequence is communicated to the TDD mobile at the beginning of the communication session.

14. A method for reducing interference to communications in Time Division Duplexing (TDD) mode according to any one of claims 10 to 12, wherein the sequences of timeslots are dynamically designated and the frequency channel and time of succeeding timeslots are communicated to the mobile in at least one preceding downlink timeslot.

15. A method for reducing interference to communications in Time Division Duplexing (TDD) mode according to any one of claims 10 to 14, wherein an operator designates the timeslots across the frequency channels allocated to that operator.

16. A method for reducing interference to communications in Time Division Duplexing (TDD) mode according to any one of claims 12 to 14, wherein an operator is provided with the sequences of timeslots available to that operator over all frequency channels available to all operators, whereby the same frequency channels and timeslots in different frames are shared by different operators.

17. A method for providing a communications channel according to claim 16, wherein the sequences of timeslots available to an operator are dynamically designated.

18. A method for providing a communications channel according to either claim 14 or claim 17, wherein the sequences of timeslots are changed during the course of a communication session.

19. A method for providing a communications channel in Time Division Duplexing (TDD) mode between a TDD mobile and a TDD base station substantially as hereinbefore described with reference to FIGS. 2 and 3 of the accompanying drawings.

20. A method for reducing interference to communications in Time Division Duplexing (TDD) mode between a TDD mobile and a TDD base station substantially as hereinbefore described with reference to FIGS. 2 and 3 of the accompanying drawings.
